(19) United States
(12) Patent Application Publication
(10) Pub. No.: US 2023/0054824 A1
(43) Pub. Date: Feb. 23, 2023

(54) POWER SAVING FOR WIRELESS REPEATERS

(71) Applicant: QUALCOMM Incorporated, San Diego, CA (US)

(72) Inventors: Navid ABEDINI, Basking Ridge, NJ (US); Tao LUO, San Diego, CA (US); Junyi LI, Fairless Hills, PA (US)

(21) Appl. No.: 17/408,137

(22) Filed: Aug. 20, 2021

(51) Int. Cl. H04W 52/02; H04W 56/00; H04W 24/10

(52) U.S. Cl. CPC H04W 52/0206; H04W 56/001; H04W 24/10

(57) ABSTRACT

Aspects of the present disclosure provide apparatus, methods, processing systems, and computer readable mediums to help conserve power for wireless repeaters. In some cases, a repeater may detect synchronization signal blocks (SSBs) for a set of one or more cells, obtain system information for one or more cells of the set, and forward one or more communications from at least one cell of the set in accordance with a schedule determined based on the system information, and the detected SSBs.

### BACKGROUND

### Field of the Disclosure

Aspects of the present disclosure relate to wireless communications, and more particularly, to techniques that may help repeaters save power.

### Description of Related Art

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3 GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

In some examples, a wireless multiple-access communication system may include a number of base stations (BSs), which are each capable of simultaneously supporting communication for multiple communication devices, otherwise known as user equipments (UEs). In an LTE or LTE-A network, a set of one or more BSs may define an eNodeB (eNB). In other examples (e.g., in a next generation, a new radio (NR), or 5G network), a wireless multiple access communication system may include a number of distributed units (DUs) (e.g., edge units (EUs), edge nodes (ENs), radio heads (RHs), smart radio heads (SRHs), transmission reception points (TRPs), etc.) in communication with a number of central units (CUs) (e.g., central nodes (CNs), access node controllers (ANCs), etc.), where a set of one or more DUs, in communication with a CU, may define an access node (e.g., which may be referred to as a BS, 5G NB, next generation NodeB (gNB or gNodeB), transmission reception point (TRP), etc.). A BS or a DU may communicate with a set of UEs on downlink channels (e.g., for transmissions from the BS or the DU to the UE) and uplink channels (e.g., for transmissions from the UE to the BS or the DU).

These multiple access technologies have been adopted in various telecommunication standards to provide a common protocol that enables different wireless devices to communicate on a municipal, national, regional, and even global level. The NR (e.g., new radio or 5G) is an example of an emerging telecommunication standard. The NR is a set of enhancements to the LTE mobile standard promulgated by 3GPP. The NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, the NR supports beamforming, multiple-input multiple-output (MIMO) antenna technology, and carrier aggregation.

However, as the demand for mobile broadband access continues to increase, there exists a need for further improvements in the NR and the LTE technology. Preferably, these improvements should be applicable to other multi-access technologies and the telecommunication standards that employ these technologies.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that may include desirable communication in integrated access and backhaul (IAB) systems.

Certain aspects provide a method for wireless communications by a wireless repeater. The method generally includes detecting synchronization signal blocks (SSBs) for a set of one or more cells, obtaining system information for one or more cells of the set, and forwarding one or more communications from at least one cell of the set in accordance with a schedule determined based on the system information, and the detected SSBs.

Certain aspects provide a method for wireless communications by a control node. The method generally includes determining one or more received power thresholds for a repeater to use in determining fronthaul beams based on received power measurements of synchronization signal blocks (SSBs) and transmitting an indication of the received power thresholds to the repeater.

Aspects of the present disclosure also provide various apparatus, means, and computer readable mediums for (or capable of) performing operations described above.

To the accomplishment of the foregoing and related ends, the one or more aspects including the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example wireless system, in accordance with certain aspects of the present disclosure.

FIG. 2 is a block diagram conceptually illustrating an example architecture of a distributed radio access network (RAN), in accordance with certain aspects of the present disclosure.

FIG. 3 illustrates example components of a base station (BS) and a user equipment (UE), in accordance with certain aspects of the present disclosure.

FIG. 4 is a block diagram illustrating an example communications protocol stack in a RAN, in accordance with certain aspects of the present disclosure.

FIG. 5 is a block diagram is a diagram illustrating an example of a frame format for new radio (NR), in accordance with certain aspects of the present disclosure.

FIG. 6 is a block diagram of an example wireless system deploying repeaters, in which aspects of the present disclosure may be implemented.

FIGS. 7A and 7B illustrate an example scenario, in which aspects of the present disclosure may be implemented.

FIG. 8 is a block diagram of an example architecture for a directional repeater.

FIG. 9 is a block diagram of an example architecture for a directional repeater, in accordance with certain aspects of the present disclosure.

FIG. 10 illustrates example operations that may be performed by a repeater, in accordance with certain aspects of the present disclosure.

FIG. 11 illustrates example operations that may be performed by a control node, in accordance with certain aspects of the present disclosure.

FIG. 12 illustrates an example power saving options for a repeater, in accordance with certain aspects of the present disclosure.

FIG. 13 illustrates a communications device that may include various components configured to perform operations for techniques disclosed herein, in accordance with aspects of the present disclosure.

FIG. 14 illustrates a communications device that may include various components configured to perform operations for techniques disclosed herein, in accordance with aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums to perform procedures that may help autonomous wireless repeaters save power. Wireless repeaters may relay directional wireless signals and may be considered enhanced (or “smart” or “autonomous”) relative to conventional repeaters that are basically limited to receiving, amplifying, and relaying radio frequency (RF) signals. Such repeaters may be considered autonomous because they may be able to detect communications (to be forwarded) by themselves. While such repeaters may function autonomously, in some cases, autonomous repeaters may obtain information that assists in their forwarding operations.

As will be described in greater detail below, a repeater may obtain information about various communications (e.g., broadcast/cell-specific/periodic communications) that are associated with synchronous signal blocks (SSBs). This information about the association may be provided via system information, for example, in a master information block (MIB) or remaining minimum system information (RMSI). Given this information, when the repeater decides to forward (or not forward) an SSB, it may also decide whether to be active (or not active) during time periods allocated for these other associated communications, such as RMSI physical downlink control channel (PDCCH) occasions, random access channel (RACH) occasions, PDCCH resources for other system information blocks (SIBS), and the like.

In some cases, for example, if the repeater is not able to receive one or more SSBs actually transmitted in a cell, it may be likely the repeater is also not able to receive the various communications associated with those SSBs. Therefore, rather than waste processing resources and the associated power, the repeater may decide to stay in a low power state for time periods associated with these communications.

The following description provides examples of techniques for coordinating beams used by the BS and the one or more directional repeater, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

The techniques described herein may be used for various wireless communication technologies, such as long-term evolution (LTE), code division multiple access (CDMA), time division multiple access (TDMA), frequency division multiple access (FDMA), orthogonal frequency-division multiple access (OFDMA), single-carrier FDMA (SC-FDMA) and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as New Radio (NR) (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS).

NR is an emerging wireless communications technology under development in conjunction with the 5G Technology Forum (5GTF). 3rd Generation Partnership Project (3GPP) LTE and LTE-Advanced (LTE-A) are releases of UMTS that use E-UTRA. UTRA, E-UTRA, UMTS, LTE, LTE-A and GSM are described in documents from an organization named 3GPP. CDMA2000 and UMB are described in documents from an organization named “3rd Generation Partnership Project 2” (3GPP2). The techniques described herein may be used for the wireless networks and radio technologies mentioned above as well as other wireless networks and radio technologies. For clarity, while aspects may be described herein using terminology commonly associated with 3G and/or 4G wireless technologies, aspects of the present disclosure can be applied in other generation-based communication systems, such as 5G and later, including NR technologies.

NR access (e.g., 5G technology) may support various wireless communication services, such as enhanced mobile broadband (eMBB) targeting wide bandwidth (e.g., 80 MHz or beyond), millimeter wave (mmW) targeting high carrier frequency (e.g., 25 GHz or beyond), massive machine type communications MTC (mMTC) targeting non-backward compatible MTC techniques, and/or mission critical targeting ultra-reliable low-latency communications (URLLC). These wireless communication services may include latency and reliability requirements. These wireless communication services may also have different transmission time intervals (TTI) to meet respective quality of service (QoS) requirements. In addition, these wireless communication services may co-exist in the same subframe.

The teachings herein may be incorporated into (e.g., implemented within or performed by) a variety of wired or wireless apparatuses (e.g., nodes). In some aspects, a wireless node implemented in accordance with the teachings herein may comprise an access point (AP) or an access terminal (AT).

The AP may comprise, be implemented as, or known as a node B (NB), a radio network controller (RNC), an evolved node B (eNB), a base station controller (BSC), a base transceiver station (BTS), a base station (BS), a transceiver function (TF), a radio router, a radio transceiver, a basic service set (BSS), an extended service set (ESS), a radio base station (“RBS”), an integrated access and backhauling (IAB) node (e.g., an IAB donor node, an IAB parent node, and an IAB child node), or some other terminology.

The AT may comprise, be implemented as, or known as a subscriber station, a subscriber unit, a mobile station, a remote station, a remote terminal, a user terminal, a user agent, a user device, a user equipment (UE), a user station, or some other terminology. In some implementations, the AT may comprise a cellular telephone, a cordless telephone, a session initiation protocol (SIP) phone, a wireless local loop (WLL) station, a personal digital assistant (PDA), a handheld device having wireless connection capability, a station (STA), or some other suitable processing device connected to a wireless modem (such as an augmented reality (AR)/virtual reality (VR) console and headset). Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music or video device, or a satellite radio), a global positioning system device, or any other suitable device that is configured to communicate via a wireless or wired medium. In some aspects, the node is a wireless node. Such wireless node may provide, for example, connectivity for or to a network (e.g., a wide area network such as the Internet or a cellular network) via a wired or wireless communication link.

### Example Wireless Communications System

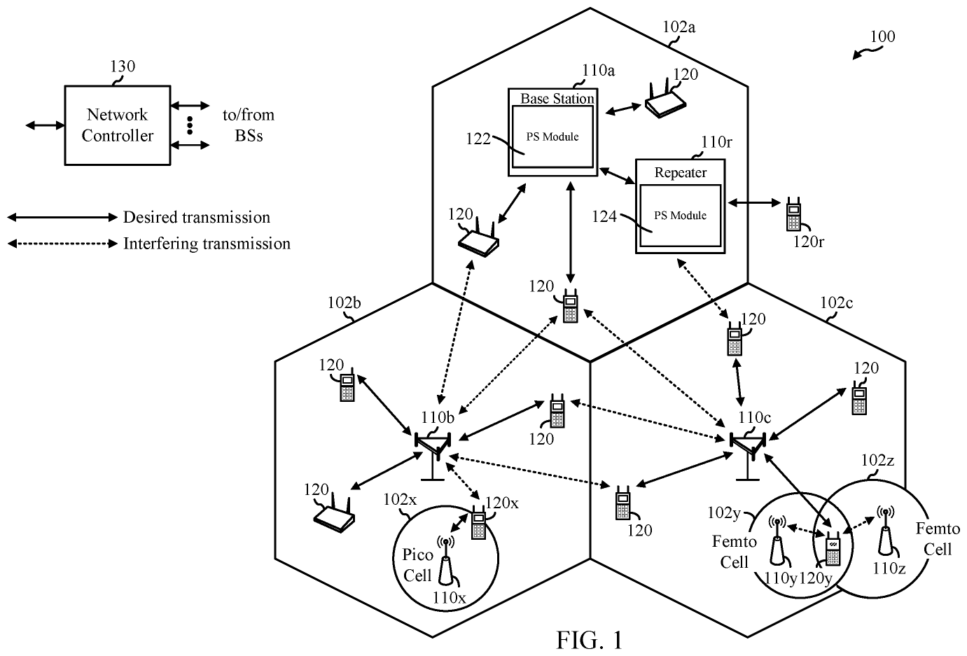

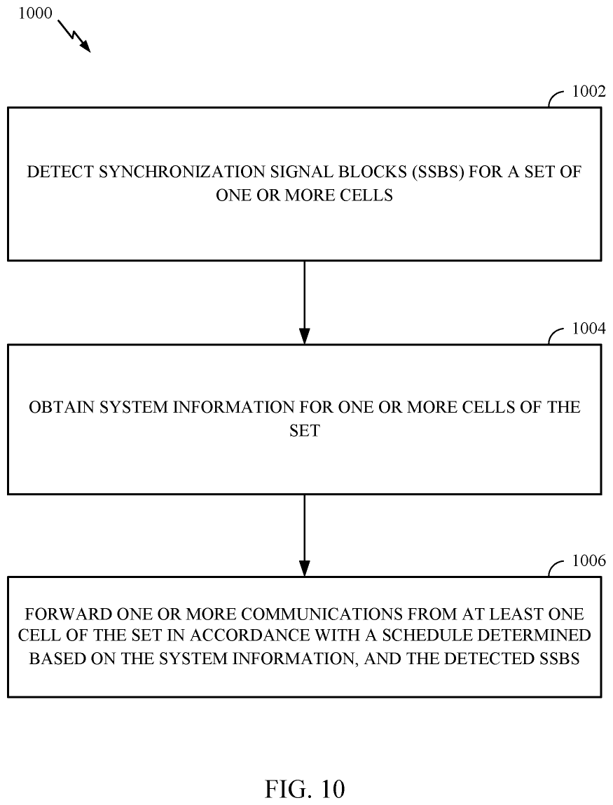

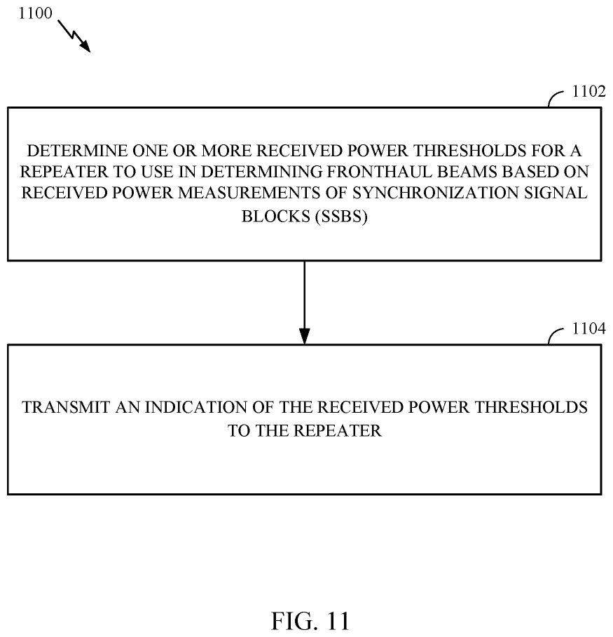

FIG. 1 illustrates an example wireless communication network 100 in which aspects of the present disclosure may be performed. For example, as shown in FIG. 1, a BS 110a may include power savings (PS) module 122, which may be designed and configured to provide information to a repeater 110r to help optimize power savings for corresponding forwarding operations. As illustrated, the repeater 110r may also have a PS module 124, for example, to perform forwarding operations in a manner that saves power, based on information received. In some cases, the repeater 110r may be configured to perform operations 1000 of FIG. 10, while the BS 110a may be configured to perform operations 1100 of FIG. 11.

The wireless communication network 100 may, for example, be a NR or 5G network. As illustrated in FIG. 1, the wireless communication network 100 may include a number of BSs (or APs) 110a-z (each also individually referred to herein as BS 110 or collectively as APs 110) and other network entities. A BS 110 may be a station that communicates with UEs 120a-y (each also individually referred to herein as UE 120 or collectively as UEs 120). Each BS 110 may provide communication coverage for a particular geographic area. In 3GPP, the term “cell” can refer to a coverage area of a NB and/or a NB subsystem serving this coverage area, depending on the context in which the term is used. In NR systems, the term “cell” and next generation NB (for example, gNB or gNodeB), NR AP, 5G NB, or transmission reception point (TRP) may be interchangeable. In some examples, the cell may not necessarily be stationary, and the geographic area of the cell may move according to a location of a mobile BS 110. In some examples, the APs 110 may be interconnected to one another and/or to one or more other APs 110 or network nodes (not shown) in the wireless communication network 100 through various types of backhaul interfaces, such as a direct physical connection, a wireless connection, a virtual network, or the like using any suitable transport network.

In general, any number of wireless networks may be deployed in a given geographic area. Each wireless network may support a particular radio access technology (RAT) and may operate on one or more frequencies. The RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs. In some cases, the NR or 5G RAT networks may be deployed.

The BS 110 may provide communication coverage for a macro cell, a pico cell, a femto cell, and/or other types of cells. The macro cell may cover a relatively large geographic area (e.g., several kilometers in radius) and may allow unrestricted access by the UEs 120 with service subscription. The pico cell may cover a relatively small geographic area and may allow unrestricted access by UEs with service subscription. A femto cell may cover a relatively small geographic area (e.g., a home) and may allow restricted access by the UEs 120 having an association with the femto cell (e.g., the UEs 120 in a closed subscriber group (CSG), the UEs 120 for users in the home, etc.). The AP for a macro cell may be referred to as a macro AP. The BS 110 for a pico cell may be referred to as a pico AP. The BS 110 for a femto cell may be referred to as a femto AP or a home AP. In the example shown in FIG. 1, the APs 110a, 110b and 110c may be macro APs for the macro cells 102a, 102b and 102c, respectively. The BS 110x may be a pico AP for a pico cell 102x. The APs 110y and 110z may be femto APs for the femto cells 102y and 102z, respectively. The BS 110 may support one or multiple (e.g., three) cells.

The wireless communication network 100 may also include relay stations. A relay station is a station that receives a transmission of data and/or other information from an upstream station (e.g., the BS 110 or the UE 120) and sends a transmission of the data and/or other information to a downstream station (e.g., the UE 120 or the BS 110). The relay station may also be the UE 120 that relays transmissions for other UEs 120. In the example shown in FIG. 1, a relay station may communicate with the BS 110a and a UE 120r in order to facilitate communication between the BS 110a and the UE 120r. The relay station may also be referred to as an IAB node, a relay AP, a relay, etc.

The wireless communication network 100 may be a heterogeneous network that includes APs 110 of different types, e.g., macro AP, pico AP, femto AP, relays, etc. These different types of APs 110 may have different transmit power levels, different coverage areas, and different impact on interference in the wireless communication network 100. For example, the macro AP may have a high transmit power level (e.g., 20 Watts) whereas the pico AP, the femto AP, and the relays may have a lower transmit power level (e.g., 1 Watt).

The wireless communication network 100 may support synchronous or asynchronous operation. For synchronous operation, the APs 110 may have similar frame timing, and transmissions from the different APs 110 may be approximately aligned in time. For asynchronous operation, the APs 110 may have different frame timing, and transmissions from the different APs 110 may not be aligned in time. The techniques described herein may be used for both synchronous and asynchronous operation.

A network controller 130 may couple to a set of APs 110 and provide coordination and control for these APs 110. The network controller 130 may communicate with the APs 110 via a backhaul. The APs 110 may also communicate with one another (e.g., directly or indirectly) via wireless or wireline backhaul.

The UEs 120 (e.g., 120x, 120y, etc.) may be dispersed throughout the wireless communication network 100, and each UE 120 may be stationary or mobile. The UE 120 may also be referred to as a mobile station, a terminal, an AT, a subscriber unit, a station, a customer premises equipment (CPE), a cellular phone, a smart phone, a PDA, a wireless modem, a wireless communication device, a handheld device, a laptop computer, a cordless phone, a WLL station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, an industrial manufacturing equipment, a global positioning system device, or any other suitable device that is configured to communicate via a wireless or wired medium. Some UEs may be considered machine-type communication (MTC) devices or evolved MTC (eMTC) devices. The MTC and the eMTC UEs may include, for example, robots, drones, remote devices, sensors, meters, monitors, location tags, etc., that may communicate with an BS 110, another device (e.g., remote device), or some other entity. A wireless node may provide, for example, connectivity for or to a network (e.g., a wide area network such as Internet or a cellular network) via a wired or wireless communication link. Some UEs 120 may be considered Internet-of-Things (IoT) devices, which may be narrowband IoT (NB-IoT) devices.

Certain wireless networks (e.g., LTE) utilize orthogonal frequency division multiplexing (OFDM) on DL and single-carrier frequency division multiplexing (SC-FDM) on UL. The OFDM and the SC-FDM partition the system bandwidth into multiple (K) orthogonal subcarriers, which are also commonly referred to as tones, bins, etc. Each subcarrier may be modulated with data. In general, modulation symbols are sent in a frequency domain with the OFDM and in a time domain with the SC-FDM. The spacing between adjacent subcarriers may be fixed, and a total number of subcarriers (K) may be dependent on a system bandwidth. For example, the spacing of the subcarriers may be 15 kHz and the minimum resource allocation (called a “resource block” (RB)) may be 12 subcarriers (or 180 kHz). Consequently, the nominal Fast Fourier Transfer (FFT) size may be equal to 128, 256, 512, 1024 or 2048 for the system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for the system bandwidth of 1.25, 2.5, 5, 10 or 20 MHz, respectively.

While aspects of the examples described herein may be associated with the LTE technologies, aspects of the present disclosure may be applicable with other wireless communications systems, such as the NR. The NR may utilize OFDM with a CP on the uplink and the downlink and include support for half-duplex operation using time division duplex (TDD). Beamforming may be supported and beam direction may be dynamically configured. Multiple-input and multiple-output (MIMO) transmissions with precoding may also be supported. MIMO configurations in the DL may support up to 8 transmit antennas with multi-layer DL transmissions up to 8 streams and up to 2 streams per UE 120. Multi-layer transmissions with up to 2 streams per UE 120 may be supported. Aggregation of multiple cells may be supported with up to 8 serving cells.

In some examples, access to the air interface may be scheduled. A scheduling entity (e.g., the BS 110) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. The APs 110 are not the only entities that may function as the scheduling entity. In some examples, the UE 120 may function as a scheduling entity and may schedule resources for one or more subordinate entities (e.g., one or more other UEs 120), and the other UEs 120 may utilize the resources scheduled by the UE 120 for wireless communication. In some examples, the UE 120 may function as the scheduling entity in a peer-to-peer (P2P) network, and/or in a mesh network. In a mesh network example, the UEs 120 may communicate directly with one another in addition to communicating with the scheduling entity.

In FIG. 1, a solid line with double arrows indicates desired transmissions between the UE 120 and the serving BS 110, which is the BS 110 designated to serve the UE 120 on the DL and/or the UL. A finely dashed line with double arrows indicates interfering transmissions between the UE 120 and the BS 110.

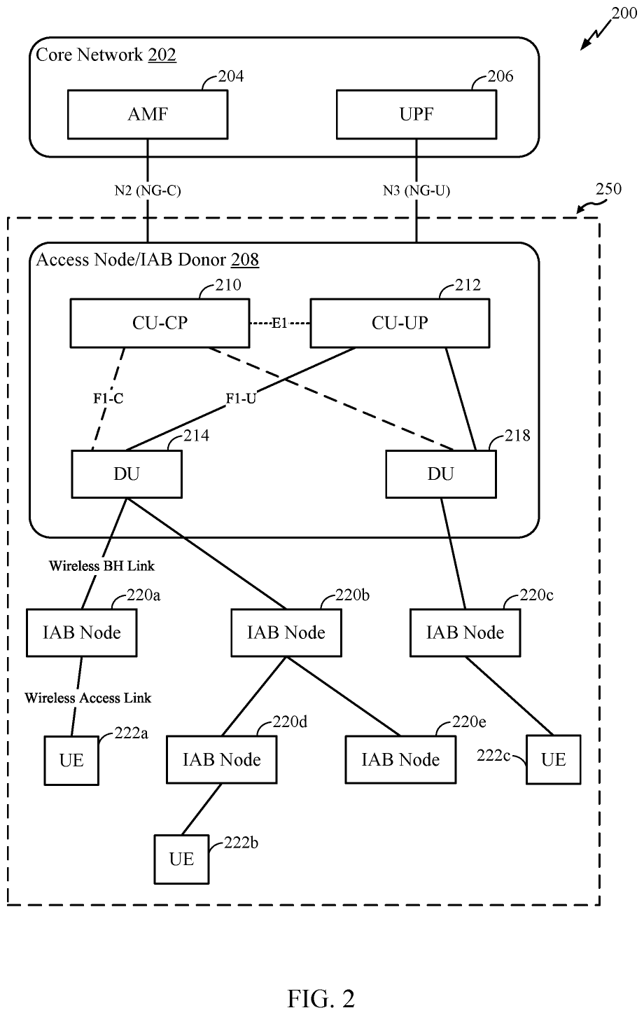

FIG. 2 illustrates an example architecture of a distributed radio access network (RAN) 200 an example IAB network 250, which may be implemented in the wireless communication network 100 illustrated in FIG. 1. As shown in FIG. 2, the distributed RAN 200 includes core network (CN) 202 and access node (AN) configured as an IAB donor 208.

As shown in FIG. 2, the IAB network 250 includes the IAB donor node 208. The IAB donor node 208 is a RAN node (e.g., access point/gNB that terminates the NR Ng interface with the CN 202 (e.g., next generation NG core)) and is generally connected to the CN 202 via a wireline backhaul link. The CN 202 may host core network functions. The CN 202 may be centrally deployed. The CN 202 functionality may be offloaded (e.g., to advanced wireless services (AWS)), in an effort to handle peak capacity. The CN 202 may include access and mobility management function (AMF) 204 and user plane function (UPF) 206. The AMF 204 and the UPF 206 may perform one or more of the CN 202 functions.

The IAB donor node 208 may communicate with the CN 202 (e.g., via a backhaul interface). The IAB donor node 208 may communicate with the AMF 204 via an N2 (e.g., NG-C) interface. The IAB donor node 208 may communicate with the UPF 206 via an N3 (e.g., NG-U) interface. The IAB donor node 208 may include a central unit-control plane (CU-CP) 210, one or more central unit-user plane (CU-UPs) 212, one or more distributed units (DUs) 214,218, and one or more antenna/remote radio units (AU/RRUs) (not shown). The CUs and DUs may also be referred to as gNB-CU and gNB-DU, respectively.

The IAB donor node 208 may also be referred to as an IAB anchor node and may include an IAB central unit (e.g., NR CU) or an IAB Distributed Unit (e.g., NR DU). The IAB network 250 further includes one or more non-donor IAB nodes (e.g., 220a-220e). Each IAB node (including donor and non-donor IAB nodes) may serve one or more UEs (e.g., 222a-222c) connected to an IAB node. As shown, the IAB nodes, including the donor IAB donor node 208, may be connected via wireless backhaul links (e.g., NR wireless backhaul links or backup NR wireless backhaul links). Each IAB node connects to its served UEs via respective access links.

Each IAB node is the RAN node (e.g., access point/gNB) that provides IAB functionality with two roles including data unit function (DU-F) and a mobile termination function (MT-F). The DU-F of the IAB node is generally responsible for scheduling UEs (e.g., served by the IAB node) and other IAB nodes (e.g., that are connected as child nodes to the IAB node). The DU-F also controls both access and backhaul links under its coverage. The MT-F of the IAB node is controlled and scheduled by the IAB donor node 208 or another IAB node as its parent IAB node. In an aspect, the IAB donor node 208 only includes DU-F and no MT-F.

The CU-CP 210 may be connected to one or more of the DUs 214, 218. The CU-CP 210 and the DUs 214, 218 may be connected via a wireline interface using F1-C protocols. As shown in FIG. 2, the CU-CP 210 may be connected to multiple DUs, but the DUs 214, 218 may be connected to only one CU-CP. Although FIG. 2 only illustrates one CU-UP 212, the IAB donor node 208 may include multiple CU-UPs. The CU-CP 210 selects the appropriate CU-UP(s) for requested services (e.g., for the UE). The CU-UP(s) 212 may be connected to the CU-CP 210. For example, the CU-UP(s) 212 and the CU-CP 210 may be connected via an E1 interface. The CU-CP(s) 212 may be connected to one or more of the DUs 214, 218. The CU-UP(s) 212 and DUs 214, 218 may be connected via a F1-U interface. As shown in FIG. 2, the CU-CP 210 may be connected to multiple CU-UPs, but the CU-UPs may be connected to only one CU-CP.

The DU, such as DUs 214 and/or 218, may host one or more transmit/receive points (TRP(s)), which may include an edge node (EN), an edge unit (EU), a radio head (RH), a smart radio head (SRH), or the like). The DU may be located at edges of the network with radio frequency (RF) functionality. The DUs 214, 216 may be connected to multiple CU-UPs 212 that are connected to (e.g., under the control of) the same CU-CP (e.g., for RAN sharing, radio as a service (RaaS), and service specific deployments). The DUs 214, 216 may be configured to individually (e.g., dynamic selection) or jointly (e.g., joint transmission) serve traffic to the UE. Each DU 214, 218 may be connected with one of AU/RRUs.

The CU-CP 210 may be connected to multiple DU(s) 214, 218 that are connected to (e.g., under control of) the same CU-UP 212. Connectivity between the CU-UP 212 and the DU 214, 218 may be established by the CU-CP 210. For example, the connectivity between the CU-UP 212 and the DU 214, 218 may be established using Bearer Context Management functions. Data forwarding between the CU-UP(s) 212 may be via a Xn-U interface.

The distributed RAN 200 may support fronthauling solutions across different deployment types. For example, the distributed RAN 200 architecture may be based on transmit network capabilities (e.g., bandwidth, latency, and/or jitter). The distributed RAN 200 may share features and/or components with the LTE. For example, the IAB donor node 208 may support dual connectivity with the NR and may share a common fronthaul for the LTE and the NR. The distributed RAN 200 may enable cooperation between and among the DUs 214, 218, for example, via the CU-CP 212. An inter-DU interface may not be used.

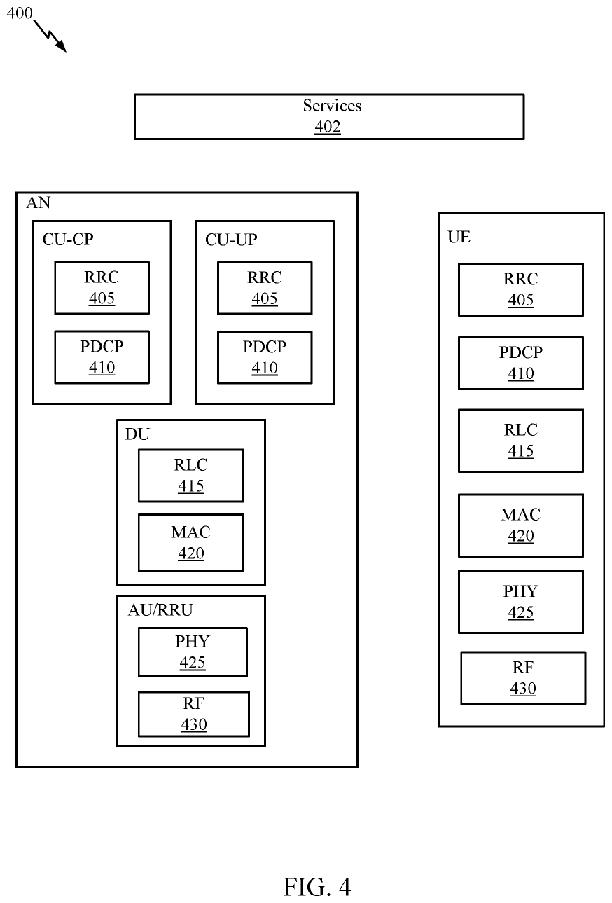

Logical functions may be dynamically distributed in the distributed RAN 200. As will be described in more detail with reference to FIG. 4, the RRC layer, Packet Data Convergence Protocol (PDCP) layer, Radio Link Control (RLC) layer, Medium Access Control (MAC) layer, Physical (PHY) layers, and/or RF layers may be adaptably placed, in the AN and/or the UE.

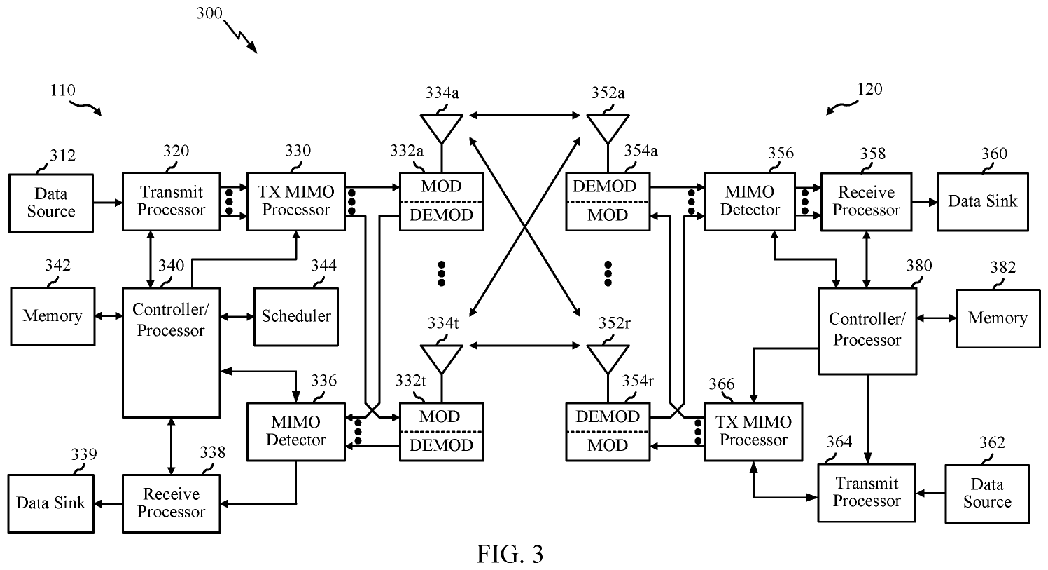

FIG. 3 illustrates example components 300 of BS 110 and UE 120 (as depicted in FIG. 1), which may be used to implement aspects of the present disclosure. For example, antennas 352, processors 366, 358, 364, and/or a controller/processor 380 of the UE 120 and/or antennas 334, processors 320, 330, 338, and/or a controller/processor 340 of the BS 110 may be used to perform various techniques and methods described herein with respect to FIG. 10 and FIG. 11.

At the BS 110, a transmit processor 320 may receive data from a data source 312 and control information from the controller/processor 340. The control information may be for a physical broadcast channel (PBCH), a physical control format indicator channel (PCFICH), a physical hybrid ARQ indicator channel (PHICH), a physical downlink control channel (PDCCH), a group common PDCCH (GC PDCCH), etc. The data may be for a physical downlink shared channel (PDSCH), etc. The processor 320 may process (e.g., encode and symbol map) the data and the control information to obtain data symbols and control symbols, respectively. The transmit processor 320 may also generate reference symbols, e.g., for a primary synchronization signal (PSS), a secondary synchronization signal (SSS), and a cell-specific reference signal (CRS). A transmit MIMO processor 330 may perform spatial processing (e.g., precoding) on the data symbols, the control symbols, and/or the reference symbols, if applicable, and may provide output symbol streams to the modulators (MODs) 332a through 332t. Each MOD 332 may process a respective output symbol stream (e.g., for OFDM, etc.) to obtain an output sample stream. Each MOD may further process (e.g., convert to analog, amplify, filter, and upconvert) the output sample stream to obtain a DL signal. The DL signals from MODs 332a through 332t may be transmitted via the antennas 334a through 334t, respectively.

At the UE 120, the antennas 352a through 352r may receive the DL signals from the BS 110 and may provide received signals to the demodulators (DEMODs) in transceivers 354a through 354r, respectively. Each DEMOD in the transceiver 354 may condition (e.g., filter, amplify, downconvert, and digitize) a respective received signal to obtain input samples. Each DEMOD in the transceiver 354 may further process the input samples (e.g., for OFDM, etc.) to obtain received symbols. A MIMO detector 356 may obtain received symbols from all the DEMODs in the transceivers 354a through 354r, to perform MIMO detection on the received symbols if applicable, and provide detected symbols. A receive processor 358 may process (e.g., demodulate, deinterleave, and decode) the detected symbols, provide decoded data for the UE 120 to a data sink 360, and provide decoded control information to a controller/processor 380.

On the UL, at the UE 120, a transmit processor 364 may receive and process data (e.g., for a physical uplink shared channel (PUSCH)) from a data source 362 and the control information (e.g., for a physical uplink control channel (PUCCH)) from the controller/processor 380. The transmit processor 364 may also generate reference symbols for a reference signal (e.g., for the sounding reference signal (SRS)). The symbols from the transmit processor 364 may be precoded by a TX MIMO processor 366 if applicable, further processed by the DEMODs in the transceivers 354a through 354r (e.g., for SC-FDM, etc.), and transmitted to the BS 110. At the BS 110, the UL signals from the UE 120 may be received by the antennas 334, processed by the MODs 332, detected by a MIMO detector 336 if applicable, and further processed by a receive processor 338 to obtain decoded data and control information sent by the UE 120. The receive processor 338 may provide the decoded data to a data sink 339 and the decoded control information to the controller/processor 340.

The controllers/processors 340 and 380 may direct the operation at the BS 110 and the UE 120, respectively. The processor 340 and/or other processors and modules at the BS 110 may perform or direct the execution of processes for the techniques described herein. Memories 342 and 382 may store data and program codes for the BS 110 and UE 120, respectively. A scheduler 344 may schedule the UEs for data transmission on the DL and/or the UL.

FIG. 4 illustrates a diagram showing examples for implementing a communications protocol stack 400 in a RAN (e.g., such as the RAN 200), according to aspects of the present disclosure. The communications protocol stack 400 may be implemented by devices operating in a wireless communication system, such as a 5G NR system (e.g., the wireless communication network 100 of FIG. 1). In various examples, layers of the communications protocol stack 400 may be implemented as separate modules of software, portions of a processor or application specific integrated circuit (ASIC), portions of non-collocated devices connected by a communications link, or various combinations thereof. Collocated and non-collocated implementations may be used, for example, in a protocol stack for a network access device or a UE. As shown in FIG. 4, the wireless communication system may support various services 402 over one or more protocols. One or more protocol layers of the communication protocol stack 400 may be implemented by an AN (e.g., AN 208 in FIG. 2, or BS 110a in FIG. 1) and/or the UE (e.g., UE 120).

As shown in FIG. 4, the communication protocol stack 400 is split in the AN. A RRC layer 405, a PDCP layer 410, a RLC layer 415, a MAC layer 420, a PHY layer 425, and a RF layer 430 may be implemented by the AN. For example, the CU-CP (e.g., CU-CP 210 in FIG. 2) and the CU-UP e.g., CU-UP 212 in FIG. 2) each may implement the RRC layer 405 and the PDCP layer 410. A DU (e.g., DUs 214 and 218 in FIG. 2) may implement the RLC layer 415 and the MAC layer 420. However, the DU may also implement the PHY layer(s) 425 and the RF layer(s) 430 via an AU/RRU connected to the DU. The PHY layers 425 may include a high PHY layer and a low PHY layer.

The UE (e.g., UE 222a-222c) may implement the entire communications protocol stack 400 (e.g., the RRC layer 405, the PDCP layer 410, the RLC layer 415, the MAC layer 420, the PHY layer(s) 425, and the RF layer(s) 430).

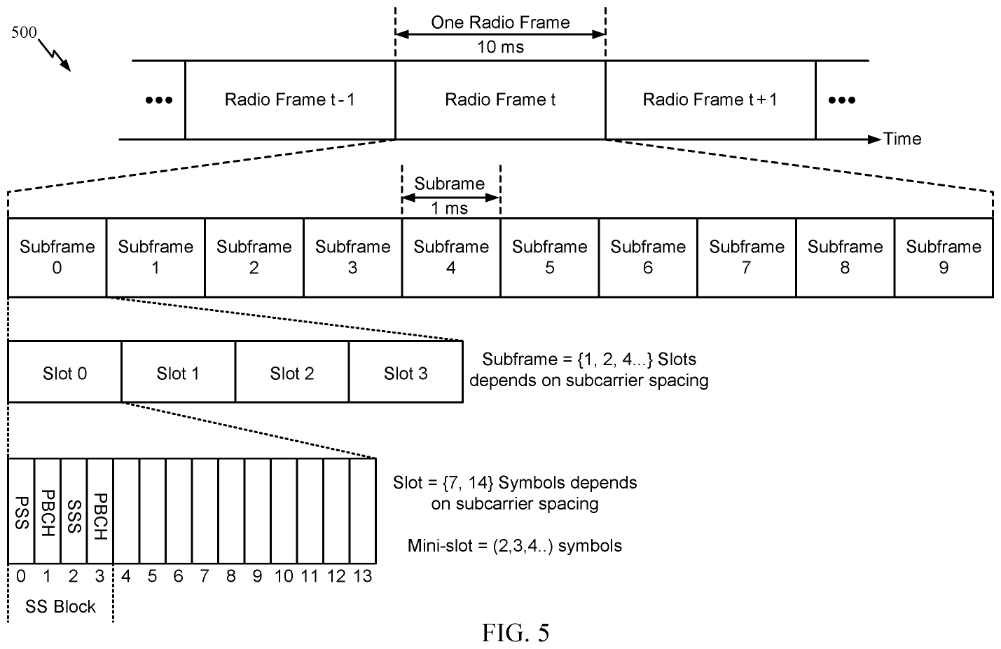

FIG. 5 is a diagram showing an example of a frame format 500 for NR. The transmission timeline for each of DL and UL may be partitioned into units of radio frames. Each radio frame may have a predetermined duration (e.g., 10 ms) and may be partitioned into 10 subframes, each of 1 ms, with indices of 0 through 9. Each subframe may include a variable number of slots depending on subcarrier spacing. Each slot may include a variable number of symbol periods (e.g., 7 or 14 symbols) depending on the subcarrier spacing. The symbol periods in each slot may be assigned indices. A mini-slot, which may be referred to as a sub-slot structure, refers to a transmit time interval having a duration less than a slot (e.g., 2, 3, or 4 symbols). Each symbol in a slot may indicate a link direction (e.g., the DL, the UL, or flexible) for data transmission and the link direction for each subframe may be dynamically switched. The link directions may be based on a slot format. Each slot may include DL/UL data as well as DL/UL control information.

In the NR, a SSB is transmitted. The SSB includes a PSS, a SSS, and a two symbol PBCH. The SSB can be transmitted in a fixed slot location, such as the symbols 0-3 as shown in FIG. 5. The PSS and the SSS may be used by UEs for cell search and acquisition. The PSS may provide half-frame timing, the SS may provide CP length and frame timing. The PSS and the SSS may provide cell identity. The PBCH carries some basic system information, such as downlink system bandwidth, timing information within radio frame, SS burst set periodicity, system frame number, etc. The SS blocks may be organized into SS bursts to support beam sweeping. Further system information such as, remaining minimum system information (RMSI), system information blocks (SIBs) such as system information block type 1 (SIB1), other system information (OSI) can be transmitted on a PDSCH in certain subframes. The SS block can be transmitted up to sixty-four times, for example, with up to sixty-four different beam directions for mmW. The up to sixty-four transmissions of the SS block are referred to as the SS burst set. The SS blocks in an SS burst set are transmitted in a same frequency region, while the SS blocks in different SS bursts sets can be transmitted at different frequency locations.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through a scheduling entity (e.g., UE or AP), even though the scheduling entity may be utilized for scheduling and/or control purposes. In some examples, the sidelink signals may be communicated using a licensed spectrum (unlike wireless local area networks, which typically use an unlicensed spectrum).

A UE may operate in various radio resource configurations, including a configuration associated with transmitting pilots using a dedicated set of resources (e.g., a RRC dedicated state, etc.) or a configuration associated with transmitting pilots using a common set of resources (e.g., an RRC common state, etc.). When operating in the RRC dedicated state, the UE may select the dedicated set of resources for transmitting a pilot signal to a network. When operating in the RRC common state, the UE may select the common set of resources for transmitting the pilot signal to the network. In either case, the pilot signal transmitted by the UE may be received by one or more network access devices, such as an AN, or a DU, or portions thereof. Each receiving network access device may be configured to receive and measure the pilot signals transmitted on the common set of resources, and also receive and measure the pilot signals transmitted on the dedicated sets of resources allocated to the UEs for which the network access device is a member of a monitoring set of network access devices for the UE. One or more of the receiving network access devices, or a CU to which the receiving network access device(s) transmit the measurements of the pilot signals, may use the measurements to identify serving cells for the UEs, or to initiate a change of the serving cell for one or more of the UEs.

### Example Directional Repeater

Next generation (5G) wireless networks have stated objectives to provide ultra-high data rate and support wide scope of application scenarios. IAB systems have been studied in 3GPP as one possible solution to help support these objectives.

As noted above, in the IAB system, a wireless backhaul solution is adopted to connect cells (IAB-nodes) to a core network (which uses a wired backhaul). Some attractive characteristics of the IAB system are support for multi-hop wireless backhaul, sharing of a same technology (e.g., NR) and resources (e.g., frequency bands) for both access and backhaul links.

There are various possible architectures for the IAB-nodes, including layer-2 (L2) and layer-3 (L3) solutions and a particular architecture deployed may depend on what layers of protocol stack are implemented in intermediate nodes (IAB-nodes), for example, L2 relays may implement PHY/MAC/RLC layers.

Certain aspects of the present disclosure relate to L1 relays (referred to as repeaters). L1 relays/repeaters may have many features. For example, such repeaters are relatively simple, low-cost, low-power, and are wirelessly connected to a donor or another relay (e.g., a gNB).

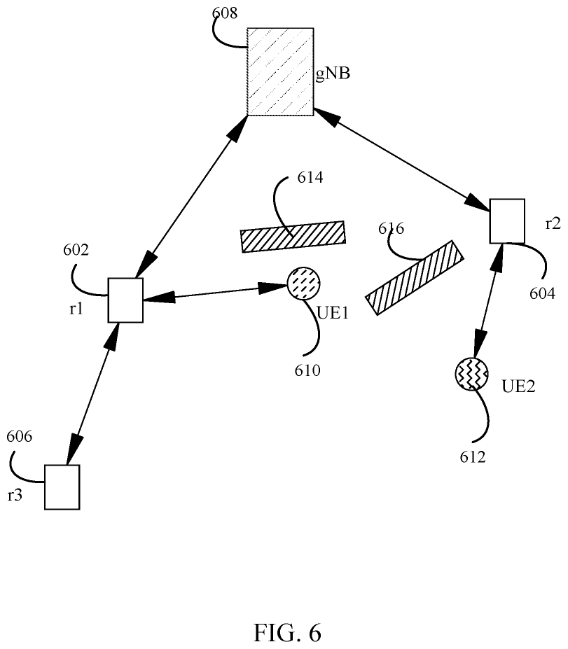

FIG. 6 illustrates one example application of how repeaters may be used to help improve coverage by overcoming blockage (for instance, obstruction of RF signals by an object). It is generally understood that the blockage is a major issue in millimeter wave (MMW) where beamforming is used to send directional RF signals. In the illustrated example, repeaters (for example, r1 602, r2 604, and r3 606) may allow a gNB 608 to serve UEs (for example, UE1 610 and UE2 612) even though objects prevent gNB directional RF signals from reaching the UEs.

As illustrated, because the r1 602 is not blocked by the objects, the r1 602 may receive the RF signals from the gNB 608 and re-transmit the RF signals to reach the UE1 610 (although the UE1 610 is blocked by the first object 614 from receiving the RF signals directly from the gNB 608). Similarly, because the r2 606 is not blocked by the objects, the r2 606 may receive the RF signals from the gNB 608 and re-transmit the RF signals to reach the UE2 612 (although the UE2 612 is blocked by the second object 616 from receiving the RF signals directly from the gNB 608). As demonstrated by this example, L 1 repeaters may serve as relatively simple and inexpensive solutions to provide protection against the blockage by the objects, extend the coverage of a MMW cell, and fill coverage holes.

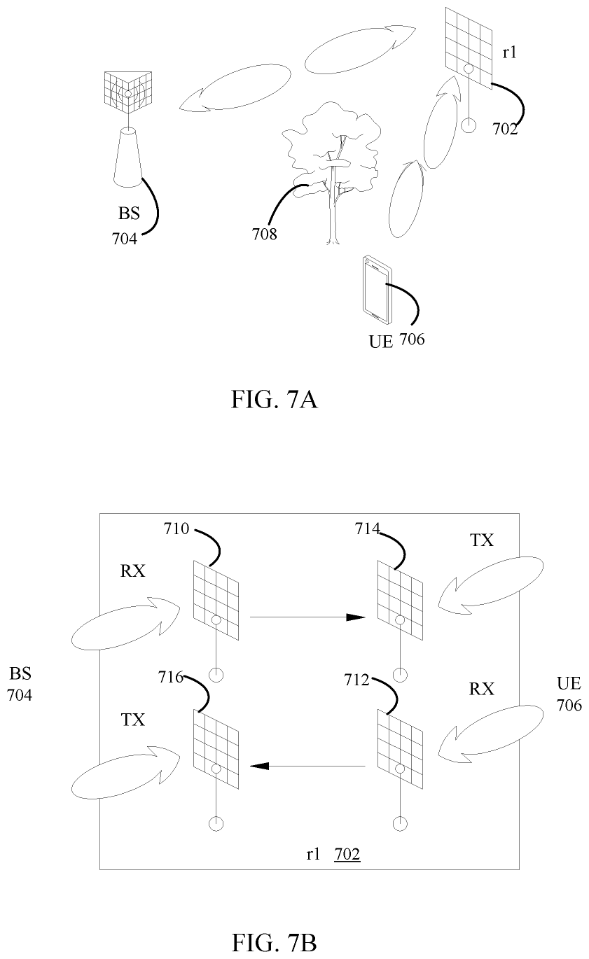

FIGS. 7A and 7B provide additional details of how repeaters may help effectively overcome challenge of a blockage by one or more objects. As illustrated in FIG. 7A, a traditional repeater receives an RF signal in one panel (corresponding to a receive or Rx beam) and (re-)transmits the RF signal in another panel (corresponding to a transmit or Tx beam). For example, the repeater simply amplifies the received RF signal and forwards the RF signal to become the transmitted RF signal (Amplify-and-forward).

In the example illustrated in FIG. 7A, a repeater r1 702 is able to receive the RF signal (for example, during DL) from a BS 704 and relay the RF signal to a UE 706, which may be blocked from receiving the RF signal directly from the BS 704 due to a presence of an object 708 (for example, a tree) between the BS 704 and the UE 706. In other direction (for example, during UL), the repeater r1 702 may receive the RF signal from the UE 706 and relay the RF signal to the BS 704.

As illustrated in FIG. 7B, the repeater r1 702 may include receive panels (for example, a first receive panel 710 and a second receive panel 712) and transmit panels (for example, a first transmit panel 714 and a second transmit panel 716), which may be used to implement some fixed beam patterns. For wide coverage, the beam patterns are usually wide, therefore not achieving high array gains. The repeater r1 702 is typically not aware of whether the RF signal is a DL signal or an UL signal in a TDD system and operates in both directions (full duplex) simultaneously.

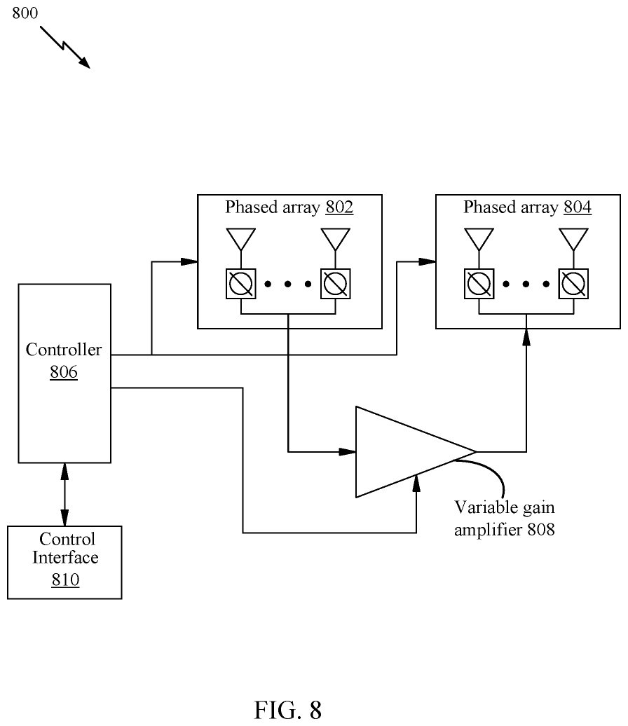

FIG. 8 illustrates a schematic view of an example architecture 800 for a repeater (e.g., an L1 repeater). As noted above, the repeater may perform operations of receiving an analog RF signal on its receiver (RX) antennas (e.g., based on some configured RX beamforming), amplifying power of the received analog RF signal, and transmitting the amplified analog RF signal from its transmitter (TX) antennas (e.g., based on some configured TX beamforming).

As illustrated, beamforming may be accomplished via phased antenna arrays (for example, a first phased antenna array 802 and a second phased antenna array 804) configured by a controller 806, while the amplification may be accomplished by a variable gain amplifier 808. The repeater may also communicate some control signals with a server (e.g., a BS serving as a donor, a control node, etc.) via a control interface 810. The control interface 810 may be implemented out-of-band (e.g., operating outside a carrier frequency on which the RX signal is received) or in-band (e.g., using a smaller bandwidth part of a same carrier frequency). An out-of-band control interface may be implemented, for example, via a separate (e.g. a low-frequency) modem using a different radio technology (for instance, a Bluetooth) or different frequency (for instance, LTE NB-IoT).

### Example Wireless Repeater

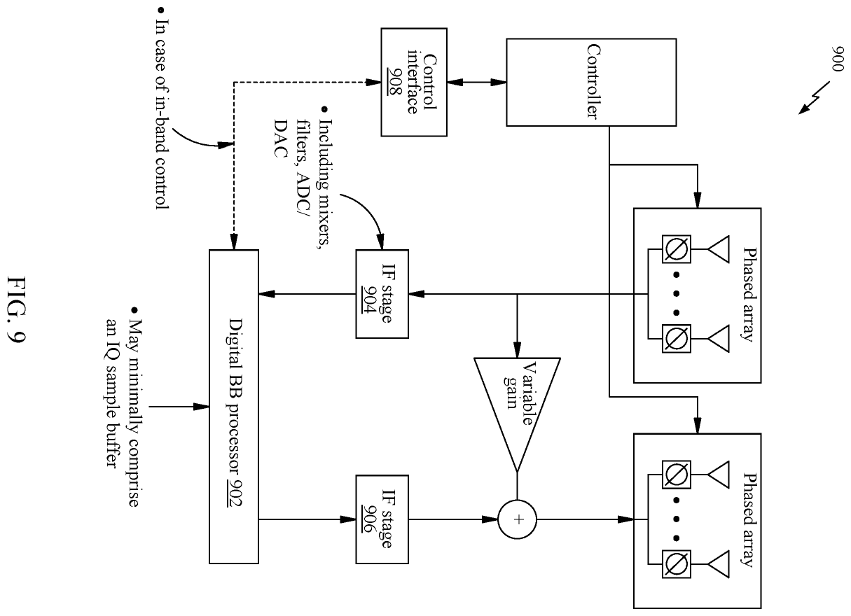

FIG. 9 shows an example architecture 900 for a (for example, a smart/enhanced/autonomous repeater), in accordance with aspects of the present disclosure. As illustrated, the enhanced repeater may have additional components when compared to a base architecture of FIG. 8, which may allow the repeater, for example, to optimize beam selection for receiving and/or transmitting RF signals. Such repeaters (e.g., considered smart/enhanced/autonomous) are just example types of repeaters for illustration purposes and the operations described herein (and corresponding claimed subject matter) are not intended to be so limited.

As illustrated, the enhanced repeater of FIG. 9 may have components that may allow the enhanced repeater to at least limited baseband processing. Such components may include a digital baseband (BB) processor 902 (with at least limited baseband capability, for example, relative to a UE or gNB). The components of the enhanced repeater may also include intermediate frequency (IF) stages (for example, a first IF stage 904 and a second IF stage 906) including mixers, filters, analog-to-digital converters (ADCs), digital-to-analog converters (DACs), and the like designed to convert a received RF signal to an IF signal, take and store digital (IQ) samples, and generate the RF signal from the stored digital samples. For this purpose, the enhanced repeater may include at least sufficient storage to implement a buffer to store the IQ samples.

The enhanced repeater of FIG. 9 may also include a control interface 908 to receive control signaling form a BS (e.g., to indicate how to store and process digital samples). As described above, the control signaling may be in-band or out-of-band. In the case of the in-band control, the digital BB processor 902 may be used to extract the control signaling from the received RF signal. In some implementations, a right branch where the digital BB processor 902 produces an output to an IF stage (for example, the first IF stage 904 or the second IF stage 906) that gets summed with an analog path for an onward link, which may not exist (or be enabled) for a link to a UE from the repeater. On the other hand, for the link from the repeater to the gNB, this branch may be used to sum the signal coming from the UE (and going to the gNB) with any locally generated signal that the repeater has to concurrently send to the gNB.

### Example Power Savings for a Repeater

Aspects of the present disclosure provide apparatus, methods, processing systems, and computer readable mediums to perform procedures that may help autonomous wireless repeaters save power.

As noted above, a simple repeater may be a relay node with amplify-and-forward operation between two wireless nodes (e.g., between a gNB and UE) and may provide a simple and cost-effective way to improve network coverage. Using side information, a decode-and-forward relay node (e.g., an IAB-node) may improve performance of a repeater. For example, such side information may include information such as timing information (e.g. Slot/Symbol/subframe/frame boundary), TDD UL/DL configuration, ON-OFF scheduling, and spatial information for beam management.

As noted above, some types of repeaters may, by itself, acquire (or infer) at least part of such side information. For example, an autonomous smart repeater may acquire the information by receiving/decoding broadcast channels (conveying system information). In some cases, a network-controlled repeater may be configured/controlled with side information by a network node (e.g., a gNB), via an established control interface. In such cases, some or all of the side information may be provided/controlled by the gNB. For example, part of the side information may be configured/controlled by gNB, while remaining side information may be acquired/inferred by the repeater itself, which may help reduce control overhead and/or latency.

For NW-controlled repeaters, the control-node (gNB) can provide the repeater with a TDD and/or ON-OFF pattern and hence let the repeater save power, for example, by turning off one of the DL or UL directions, or both of them if there is no communications to be forwarded by the repeater.

For some types of repeaters (e.g., which may be considereed autonomous repeaters), there may be no such control interface between control-node and the repeater to provide such a repeater configuration. Rather, such a repeater may measure receive (Rx) power on its input antennas and decide whether there is any incoming signal. If the repeater decides there is no incoming signal to forward, it can turn off some/all of its forwarding chain(s).

According to aspects of the present disclosure, a repeater may have sufficient radio frequency (RF) processing resources (e.g., a simplified UE-type modem) that can acquire SSBs and read various system information (e.g., MIB/RMSI and possibly other broadcast SIBs). The repeater may employ a power-saving schedule based on this information (e.g., deciding when to be active in forwarding and/or when to turn off forwarding to save power).

For example, if the repeater is not able to receive one or more SSBs actually transmitted in a cell, it may be likely the repeater is also not able to receive the various communications associated with those SSBs. Therefore, rather than waste processing resources and the associated power, the repeater may decide to stay in a low power state for time periods associated with these communications

FIG. 10 illustrates example operations 1000 for wireless communication by a repeater, in accordance with certain aspects of the present disclosure. The operations 1000 may be performed, for example, by a repeater (e.g., any of the repeaters shown in FIG. 1, 6, 7, or 9 or any electronic device acting as a repeater).

Operations 1000 begin, at 1002, by detecting synchronization signal blocks (SSBs) for a set of one or more cells. At 1004, the repeater obtains system information for one or more cells of the set. At 1006, the repeater obtains system information for one or more cells of the set.

FIG. 11 illustrates example operations 1100 for wireless communication that may be considered complementary to operations 1000 of FIG. 10. For example, operations 1100 may be performed by a control node (e.g., a BS/gNB shown in FIG. 1, 6, 7, or 9) to provide information that may help (configure) a repeater to perform operations 1000 of FIG. 10.

Operations 1100 begin, at 1102, by determining one or more received power thresholds for a repeater to use in determining fronthaul beams based on received power measurements of synchronization signal blocks (SSBs). At 1104, the control node transmits an indication of the received power thresholds to the repeater.

In some cases, additional details of the repeater operations of FIG. 10 may be as follows. To detect SSBs, the repeater may first search for near-by cells (e.g., by running a PSS/SSS searcher algorithm). Based on PSS/SSS pairs found as a result of this search, the repeater detects one or multiple cells.

The repeater may also acquire corresponding MIBs (and possibly additionally other SIBs) for a subset (or all of) the detected cell(s). The repeater may the select one or multiple cells to be associated with and forwards their communications.

For a selected cell, the repeater will have already identified one or multiple SSBs that it can receive. The repeater may use corresponding front-haul beam(s), corresponding to these SSBs, for its (future) forwarding operations.

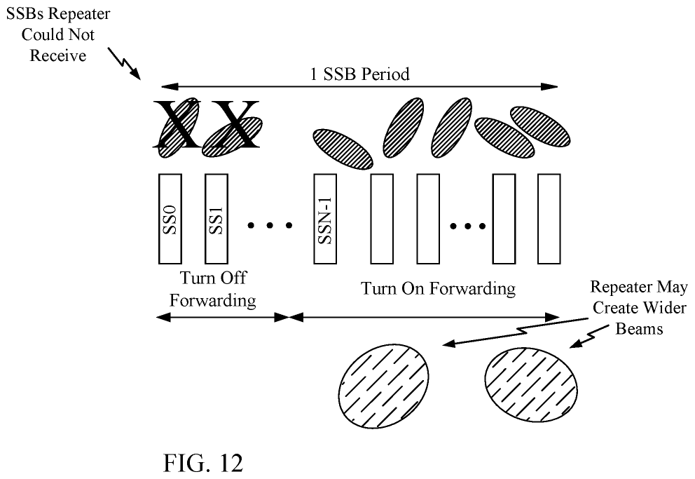

In some cases, the repeater may perform a sub-selection (e.g., selecting a subset) of SSBs/fronthaul beams, in the event that multiple SSBs can be detected. An example of such sub-selection is shown in FIG. 12.

For example, the repeater may perform a sub-selection of SSB/fronthaul beams based on measured power (e.g., reference signal received power-RSRP) and some indicated/preconfigured (RSRP) thresholds.

In the illustrated example, the repeater is unable to detect SSB0 and SSB1 (e.g., the RSRP for these SSBs is below a configured threshold). As a result, the sub-selection may exclude these SSBs. As a result, forwarding of these non-selected SSBs may not be performed. Further, forwarding of communications associated with these non-selected SSBs may also not be performed. For example, the repeater may obtain/infer information about communications (e.g., MIB/SIB, and associated PDCCH transmissions) from system information.

As also illustrated in FIG. 12, in some cases, a repeater may be able to create a wider beam that can be used for receiving two or multiple SSBs. In such cases, the repeater may also use this beam on its fronthaul (FH).

In some cases, a repeater may have multiple antenna arrays and/or multiple forwarding chains. In such cases, the repeater may select (and/or sub-select) multiple beams (corresponding to multiple SSBs) on its FH.

In some cases, a repeater may learn of SSB actually transmitted by a cell and determine a first set of SSBs (of the actually transmitted SSBs) that it could not receive or did not select. As in the example shown in FIG. 12, the repeater may then turn off its forwarding operation on the corresponding SSB symbols. While not shown in FIG. 12, the repeater may also turn off forwarding to communications associated with these (non-received/non-selected) SSBs, such as the associated RMSI PDCCH resources (e.g., acquired from MIB), associated RACH occasions, associated PDCCH resources for other SIBS, RAR, paging, and the like.

In some cases, the repeater may also determine a second set of SSBs (of the actually transmitted SSBs) that it could receive and, from this second set, the repeater may select SSBs for its association/forwarding operation. The repeater may then decide to stay ON (on the proper DL/UL direction) within the corresponding SSB symbols, and the associated RMSI PDCCH resources (e.g., acquired from MIB), associated RACH occasions, associated PDCCH resources for other SIBS, RAR, paging, and the like.

In some cases, a repeater may be deployed with an RX power-based ON/OFF pattern that indicates when the repeater is to have forwarding turned on and off. However, by learning the first set of SSBs (the repeater does not receive/select) and the second set of SSBs (the repeater can receive/selects), the repeater may not use such an RX power-based ON/OFF pattern. Rather, the repeater may decide to stay ON to forward the second set of SSBs and associated communications (e.g., to assure it will not miss forwarding important access-related signals). Similarly, the repeater may decide to be OFF and not forward the second set of SSBs and associated communications (e.g., in order to conserve power).

As discussed, the techniques presented herein may help a repeater conserve power by selecting when to perform forwarding of SSBs and various associated communications. The information about the communications associated with SSBs may be acquired from system information (e.g., provided in the MIB/RMSI). A significant amount of communications may be associated with SSBs, such as other broadcast/cell-specific/periodic communications in both DL and UL. So, when the repeater decides to forward (or not forward) an SSB, it may also decide to be active (or not active) during other “associated” resources allocated for these other communications—such as RMSI PDCCH, RACH occasions, PDCCH resources for other SIBs, and the like.

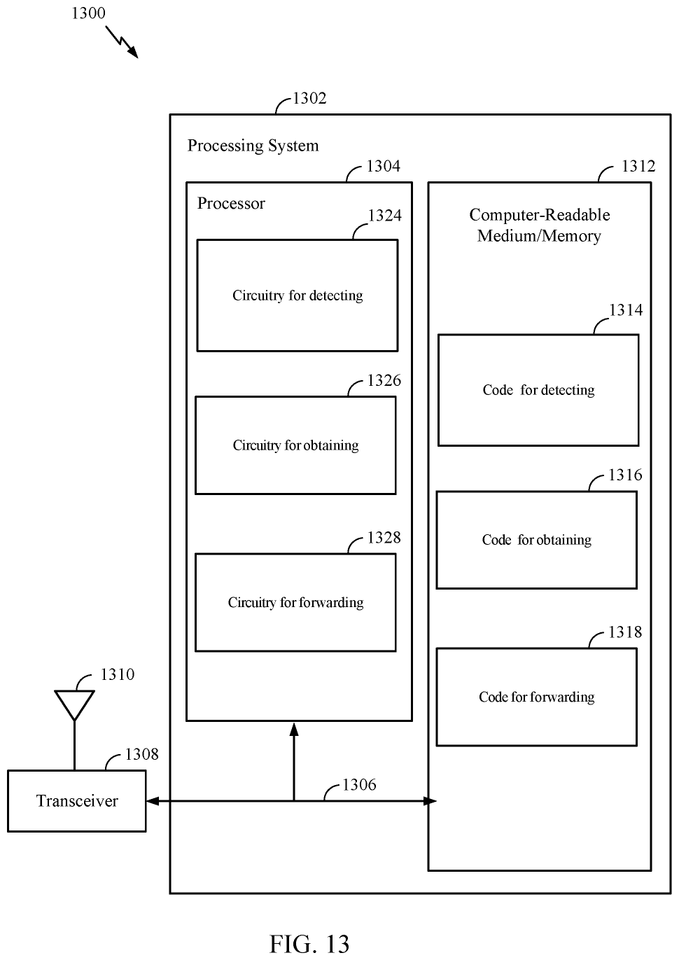

FIG. 13 illustrates an example communications device 1300 that may include various components (e.g., corresponding to means-plus-function components) configured to perform operations for the techniques disclosed herein. For example, the device 1300 may be a repeater configured to perform operations illustrated in FIG. 10. The communications device 1300 includes a processing system 1302 coupled to a transceiver 1308 (e.g., a transmitter and/or a receiver). The transceiver 1308 is configured to transmit and receive signals for the communications device 1300 via an antenna 1310, such as the various signals as described herein. The processing system 1302 may be configured to perform processing functions for the communications device 1300, including processing signals received and/or to be transmitted by the communications device 1300.

The processing system 1302 includes a processor 1304 coupled to a computer-readable medium/memory 1312 via a bus 1306. In certain aspects, the computer-readable medium/memory 1312 is configured to store instructions (e.g., computer-executable code) that when executed by the processor 1304, cause the processor 1304 to perform the operations illustrated in FIG. 10, or other operations for performing the various techniques discussed herein. In certain aspects, computer-readable medium/memory 1312 stores code 1314 for detecting (that may be used to perform the various detecting operations of FIG. 10); and code 1316 for obtaining (that may be used to perform the various obtaining operations of FIG. 10); and code 1316 for forwarding (that may be used to perform the various forwarding operations of FIG. 10), etc. In certain aspects, the processor 1304 has circuitry configured to implement the code stored in the computer-readable medium/memory 1312. The processor 1304 includes circuitry 1324 for detecting (that may be used to perform the various detecting operations of FIG. 10); circuitry 1326 for obtaining (that may be used to perform the various obtaining operations of FIG. 10); and circuitry 1328 for forwarding (that may be used to perform the various forwarding operations of FIG. 10).

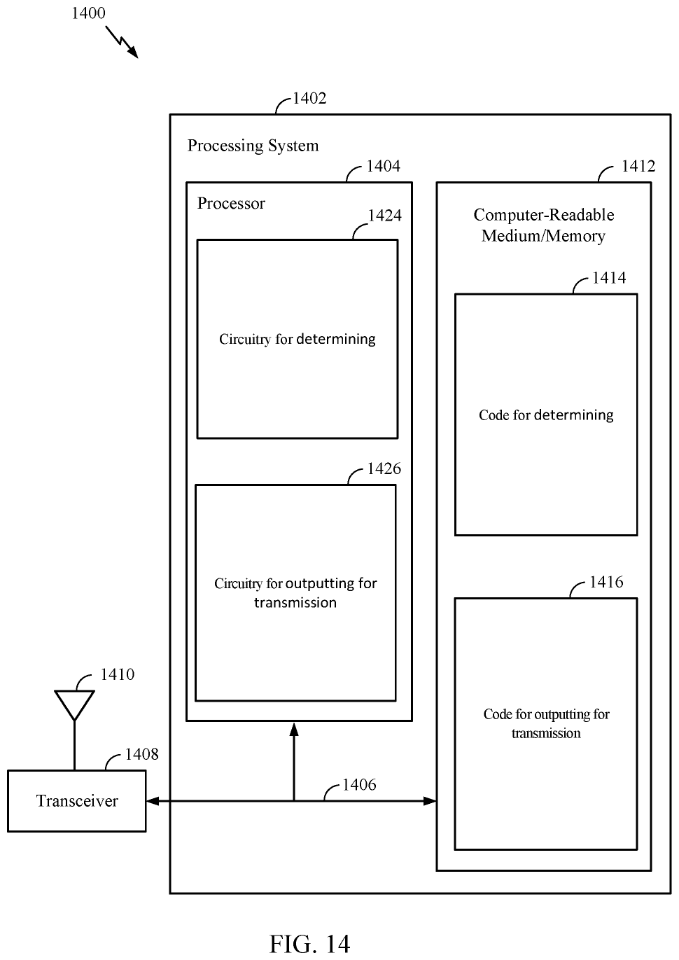

FIG. 14 illustrates an example communications device 1400 that may include various components (e.g., corresponding to means-plus-function components) configured to perform operations for the techniques disclosed herein. For example, the device 1400 may be a control node (e.g., a gNB) configured to perform operations illustrated in FIG. 11. The communications device 1400 includes a processing system 1402 coupled to a transceiver 1408 (e.g., a transmitter and/or a receiver). The transceiver 1408 is configured to transmit and receive signals for the communications device 1400 via an antenna 1410, such as the various signals as described herein. The processing system 1402 may be configured to perform processing functions for the communications device 1400, including processing signals received and/or to be transmitted by the communications device 1400.

The processing system 1402 includes a processor 1404 coupled to a computer-readable medium/memory 1412 via a bus 1406. In certain aspects, the computer-readable medium/memory 1412 is configured to store instructions (e.g., computer-executable code) that when executed by the processor 1404, cause the processor 1404 to perform the operations illustrated in FIG. 11, or other operations for performing the various techniques discussed herein. In certain aspects, computer-readable medium/memory 1412 stores code 1414 for determining (that may be used to perform the various determining operations of FIG. 11); and code 1416 for outputting for transmission (that may be used to perform the various transmitting operations of FIG. 11). In certain aspects, the processor 1404 has circuitry configured to implement the code stored in the computer-readable medium/memory 1412. The processor 1404 includes circuitry 1424 for determining (that may be used to perform the various determining operations of FIG. 11); and circuitry 1426 for outputting for transmission (that may be used to perform the various transmitting operations of FIG. 11).

### Example Aspects

In addition to the various aspects described above, specific combinations of aspects are within the scope of the disclosure, some of which are detailed below:

Aspect 1: A method for wireless communications by a repeater, comprising: detecting synchronization signal blocks (SSBs) for a set of one or more cells; obtaining system information for one or more cells of the set; and forwarding one or more communications from at least one cell of the set in accordance with a schedule determined based on the system information and the detected SSBs.

Aspect 2: The method of Aspect 1, wherein the system information comprises at least one of a master information block (MIB) or remaining minimum system information (RMSI).

Aspect 3: The method of any one of Aspects 1-2, further comprising: determining one or more fronthaul beams based on the detected SSBs, wherein the one or more communications are forwarded by using the one or more fronthaul beams.

Aspect 4: The method of Aspect 3, wherein the one or more fronthaul beams are determined based on measured received power of the detected SSBs and one or more received power thresholds.

Aspect 5: The method of Aspect 4, further comprising receiving an indication of the one or more received power thresholds from a control node.

Aspect 6: The method of Aspect 5, wherein: the repeater is configured to receive and forward communications on a first radio access technology (RAT) or a first frequency range; and the repeater receives the indication from the control node via a second RAT or a second frequency range.

Aspect 7: The method of Aspect 5, wherein the repeater receives the indication from the control node via an Internet Protocol (IP) network.

Aspect 8: The method of Aspect 3, wherein the one or more fronthaul beams comprise at least one beam wide enough to be used for receiving multiple SSBs.

Aspect 9: The method of Aspect 3, wherein the one or more fronthaul beams comprise multiple beams corresponding to the detected SSBs.

Aspect 10: The method of any one of Aspects 1-9, wherein the system information indicates SSBs transmitted by one or more cells of the set.

Aspect 11: The method of Aspect 10, wherein the schedule results in refraining from performing one or more forwarding operations for communications associated with one or more of the transmitted SSBs that the repeater could not receive or did not select.

Aspect 12: The method of Aspect 11, further comprising obtaining information about the communications associated with the SSBs that the repeater could not receive or did not from the system information.

Aspect 13: The method of Aspect 11, wherein the schedule results from adjusting a received power based forwarding pattern, so the repeater is in a low power state during the transmitted SSBs that the repeater could not receive or did not select and associated transmissions.

Aspect 14: The method of Aspect 10, wherein the schedule results in performing one or more forwarding operations for a subset of the transmitted SSBs that the repeater could receive or did select.

Aspect 15: The method of Aspect 14, wherein the schedule results from adjusting a received power based forwarding pattern, so the repeater avoids a low power state during the transmitted SSBs that the repeater could receive or did select and associated transmissions.

Aspect 16: The method of any one of Aspects 1-14, wherein the repeater comprises a smart repeater, an enhanced repeater, an autonomous repeater, or some combination thereof.

Aspect 17: A method for wireless communications by a control node, comprising: determining one or more received power thresholds for a repeater to use in determining fronthaul beams based on received power measurements of synchronization signal blocks (SSBs); and transmitting an indication of the one or more received power thresholds to the repeater.

Aspect 18: The method of Aspect 17, wherein the indication is transmitted in system information.

Aspect 19: The method of Aspect 18, wherein the system information comprises at least one of a master information block (MIB) or a remaining minimum system information (RMSI).

Aspect 20: The method of any one of Aspects 17-19, wherein: the repeater is configured to receive and forward communications on a first radio access technology (RAT) or a first frequency range; and the control node transmits the indication via a second RAT or a second frequency range.

Aspect 21: The method of any one of Aspects 17-20, wherein the control node transmits the indication via an Internet Protocol (IP) network.

Aspect 22: The method of any one of Aspects 17-21, wherein the repeater comprises a smart repeater, an enhanced repeater, an autonomous repeater, or some combination thereof.

Aspect 23: A repeater, comprising means for performing the operations of one or more of Aspects 1-16.

Aspect 24: A repeater, comprising a transceiver and a processing system including at least one processor configured to perform the operations of one or more of Aspects 1-16.

Aspect 25: A control node, comprising means for performing the operations of one or more of Aspects 17-22.

Aspect 26: A control node, comprising a transceiver and a processing system including at least one processor configured to perform the operations of one or more of Aspects 17-22.

Aspect 27: An apparatus for wireless communications by a repeater, comprising: a processing system configured to detect synchronization signal blocks (SSBs) for a set of one or more cells; and an interface configured to obtain system information for one or more cells of the set, wherein the processing system is further configured to forwarding one or more communications from at least one cell of the set in accordance with a schedule determined based on the system information and the detected SSBs.

Aspect 28: An apparatus for wireless communications by a control node, comprising: a processing system configured to determine one or more received power thresholds for a repeater to use in determining fronthaul beams based on received power measurements of synchronization signal blocks (SSBs); and an interface configured to output for transmission an indication of the one or more received power thresholds to the repeater.

Aspect 29: A computer-readable medium wireless communications comprising codes executable by an apparatus to: detect synchronization signal blocks (SSBs) for a set of one or more cells; obtain system information for one or more cells of the set; and forward one or more communications from at least one cell of the set in accordance with a schedule determined based on the system information and the detected SSBs.

Aspect 30: A computer-readable medium wireless communications comprising codes executable by an apparatus to: determine one or more received power thresholds for a repeater to use in determining fronthaul beams based on received power measurements of synchronization signal blocks (SSBs); and output for transmission an indication of the one or more received power thresholds to the repeater.

### Additional Considerations

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover a, b, c, a-b, a-c, b-c, and a-b-c, as well as combinations that include multiples of one or more members (aa, bb, and/or cc).

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Means for receiving or means for obtaining may include a receiver (such as the receive processor 338) or an antenna(s) 334 of the BS 110 or the receive processor 358 or antenna(s) 352 of the UE 120 illustrated in FIG. 3. Means for transmitting or means for outputting may include a transmitter (such as the transmit processor 320) or an antenna(s) 334 of the BS 110 or the transmit processor 364 or antenna(s) 352 of the UE 120 illustrated in FIG. 3. Means for detecting, means for forwarding, means for determining, and/or means for performing may include a processing system, which may include one or more processors, such as the receive processor 338/358, the transmit processor 320/364, the TX MIMO processor 330/366, or the controller 340/380 of the BS 110 and the UE 120 illustrated in FIG. 3.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

The functions described may be implemented in hardware, software, firmware, or any combination thereof. If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the wireless node, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or access point as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or access point can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for wireless communications by a repeater, comprising:
detecting synchronization signal blocks (SSBs) for a set of one or more cells;
obtaining system information for one or more cells of the set of one or more cells; and
forwarding one or more communications from at least one cell of the set of one or more cells in accordance with a schedule determined based on the system information and the detected SSBs.

2. The method of claim 1, wherein the system information comprises at least one of a master information block (MIB) or remaining minimum system information (RMSI).

3. The method of claim 1, further comprising:
determining one or more fronthaul beams based on the detected SSBs, wherein the one or more communications are forwarded by using the one or more fronthaul beams.

4. The method of claim 3, wherein the one or more fronthaul beams are determined based on measured received power of the detected SSBs and one or more received power thresholds.

5. The method of claim 4, further comprising receiving an indication of the one or more received power thresholds from a control node.

6. The method of claim 5, wherein:
the repeater is configured to receive and forward communications on a first radio access technology (RAT) or a first frequency range; and
the repeater receives the indication from the control node via a second RAT or a second frequency range.

7. The method of claim 5, wherein the repeater receives the indication from the control node via an Internet Protocol (IP) network.

8. The method of claim 3, wherein the one or more fronthaul beams comprise at least one beam wide enough to be used for receiving multiple SSBs.

9. The method of claim 3, wherein the one or more fronthaul beams comprise multiple beams corresponding to the detected SSBs.

10. The method of claim 1, wherein the system information indicates SSBs transmitted by one or more cells of the set of one or more cells.

11. The method of claim 10, wherein the schedule results in refraining from performing one or more forwarding operations for communications associated with one or more of the transmitted SSBs that the repeater could not receive or did not select.

12. The method of claim 11, further comprising obtaining information about the communications associated with the SSBs that the repeater could not receive or did not from the system information.

13. The method of claim 11, wherein the schedule results from adjusting a received power based forwarding pattern, so the repeater is in a low power state during the transmitted SSBs that the repeater could not receive or did not select and associated transmissions.

14. The method of claim 10, wherein the schedule results in performing one or more forwarding operations for a subset of the transmitted SSBs that the repeater could receive or did select.

15. The method of claim 14, wherein the schedule results from adjusting a received power based forwarding pattern, so the repeater avoids a low power state during the transmitted SSBs that the repeater could receive or did select and associated transmissions.

16. A method for wireless communications by a control node, comprising:
determining one or more received power thresholds for a repeater to use in determining fronthaul beams based on received power measurements of synchronization signal blocks (SSBs); and
transmitting an indication of the one or more received power thresholds to the repeater.

17. The method of claim 16, wherein the indication is transmitted in system information.

18. The method of claim 17, wherein the system information comprises at least one of a master information block (MIB) or a remaining minimum system information (RMSI).

19. The method of claim 16, wherein:
the repeater is configured to receive and forward communications on a first radio access technology (RAT) or a first frequency range; and
the control node transmits the indication via a second RAT or a second frequency range.

20. The method of claim 16, wherein the control node transmits the indication via an Internet Protocol (IP) network.

21. A repeater, comprising:
a processing system configured to detect synchronization signal blocks (SSBs) for a set of one or more cells; and
a receiver configured to receive system information for one or more cells of the set of one or more cells, wherein:
the processing system is further configured to forward one or more communications from at least one cell of the set of one or more cells in accordance with a schedule determined based on the system information and the detected SSBs.

22. The repeater of claim 21, wherein at least one of:
the system information comprises at least one of a master information block (MIB) or remaining minimum system information (RMSI); or
the system information indicates SSBs transmitted by one or more cells of the set of one or more cells.

23. The repeater of claim 21, wherein the processing system is further configure to:
determine one or more fronthaul beams based on the detected SSBs, wherein the one or more communications are forwarded by using the one or more fronthaul beams.

24. The repeater of claim 23, wherein the one or more fronthaul beams are determined based on measured received power of the detected SSBs and one or more received power thresholds.

25. The repeater of claim 24, wherein the receiver is further configured to receive an indication of the one or more received power thresholds from a control node.

26. The repeater of claim 25, wherein at least one of:
the repeater is configured to receive and forward communications on a first radio access technology (RAT) or a first frequency range and receives the indication from the control node via a second RAT or a second frequency range; or
the repeater receives the indication from the control node via an Internet Protocol (IP) network.

27. The repeater of claim 23, wherein at least one of:
the one or more fronthaul beams comprise at least one beam wide enough to be used for receiving multiple SSBs; or
the one or more fronthaul beams comprise multiple beams corresponding to the detected SSBs.

28. A control node, comprising:
a processing system configured to determine one or more received power thresholds for a repeater to use in determining fronthaul beams based on received power measurements of synchronization signal blocks (SSBs); and
a transmitter configured to transmit an indication of the one or more received power thresholds to the repeater.

29. The control node of claim 28, wherein at least one of:
the indication is transmitted in system information;
the repeater is configured to receive and forward communications on a first radio access technology (RAT) or a first frequency range and the control node transmits the indication via a second RAT or a second frequency range; or
the control node transmits the indication via an Internet Protocol (IP) network.

30. The control node of claim 29, wherein the system information comprises at least one of a master information block (MIB) or a remaining minimum system information (RMSI).
